(19) United States
(12) Patent Application Publication
(10) Pub. No.: US 2016/0225179 A1
(43) Pub. Date: Aug. 4, 2016

(54) THREE-DIMENSIONAL VISUALIZATION OF A SCENE OR ENVIRONMENT

(71) Applicant: Institute of Environmental Science and Research Limited, Porirua (NZ)

(72) Inventors: Dion James Sheppard, Auckland (NZ); Jason Barr, Auckland (NZ); Sebastian Merino, Auckland (NZ); Tom Campbell, Auckland (NZ)

(21) Appl. No.: 15/009,763

(22) Filed: Jan. 28, 2016

Related U.S. Application Data
(60) Provisional application No. 62/109,566, filed on Jan. 29, 2015.

(51) Int. Cl. G06T 15/04; G06T 11/60; G06F 17/24; G06T 5/00; G06T 9/00; G06T 19/20; G06T 19/00; G06T 17/30; G06F 17/22

(52) U.S. Cl. CPC G06T 15/04; G06T 17/30; G06T 11/60; G06F 17/241; G06F 17/2235; G06T 9/00; G06T 19/20; G06T 19/003; G06T 5/002; G06T 2215/16; G06T 2219/004

(57) ABSTRACT

The present disclosure relates to a system and method for visualizing and interacting with a three-dimensional scene according to one or more aspects of the disclosure. In some examples, a user may visualize a scene or any other environment representing three-dimensional data to allow for inspection, annotation, etc. of the scene in order to facilitate understanding of one or more events that occurred at the scene. The scene can also include the scene of an accident, building development, film set or location, or any other type of three-dimensional visualization of a real life scene.

### RELATED APPLICATIONS

The present application claims priority to U.S. Provisional Application Ser. No. 62/109,566, filed Jan. 29, 2015, entitled THREE-DIMENSIONAL VISUALIZATION OF A SCENE OR ENVIRONMENT, the entire contents of which are herein incorporated by reference.

### FIELD OF THE INVENTION

The present disclosure relates to a system and method for visualizing and interacting with a three-dimensional (3D) scene or environment according to one or more aspects of the disclosure.

### BACKGROUND OF THE INVENTION

There is a growing world-wide trend toward using laser scanning to record crime scenes, accidents, building development, film sets and locations, and many other environments. Laser scanner users are proficient at capturing laser scan data, but are unable to quickly convert the raw data into “relevant and reliable” visual outputs. Currently, complicated workflows and software combinations are utilized to create rendered visualizations. This requires significant investment in time and money, and is deterring some potential laser scanner users from implementing laser scanning. To view the resulting 3D visualizations often requires a software install and 3D model-manipulation experience, making sharing with interested parties difficult.

### SUMMARY OF THE INVENTION

One aspect of the disclosure provides a system for visualizing three-dimensional (3D) data, comprising: a conversion module configured to convert the 3D data into one or more mipmaps; a visualization module configured to display a photorealistic, three dimensional scene corresponding to the one or more mipmaps, the visualization module displaying the scene using fuzzy spheres without meshing, surfacing, and/or modeling the 3D data.

In one example, the system includes an annotation module configured to annotate the three-dimensional scene.

In one example, the annotation module is configured to provide at least one of: measurements within a scene; hotspots; text annotations; snapshots; and DXF data.

In one example, the hotspots are displayed within the three-dimensional scene.

In one example, the one or more mipmaps comprises a plurality of successive mipmaps of decreasing data density.

Another aspect of the disclosure provides a system for annotating a three-dimensional visualization, comprising: a conversion module configured to convert three-dimensional data into one or more mipmaps; a visualization module configured to display a three dimensional scene corresponding to the one or more mipmaps, the visualization module further configured to display a measurement value corresponding to a distance between coordinates of two points among the point cloud data, the measurement value corresponding to a real life distance measurement of a scene corresponding to the three-dimensional data.

Another aspect of the disclosure provides a system for annotating a three-dimensional visualization, comprising: a conversion module configured to convert three-dimensional data into one or more mipmaps; a visualization module configured to display a three dimensional scene corresponding to the one or more mipmaps, the visualization module further configured to display at least one hotspot within the visualization, the hotspot corresponding to a linked multimedia file and a coordinate of the three-dimensional data.

Another aspect of the disclosure provides a system for annotating a three-dimensional visualization, comprising: a conversion module configured to convert three-dimensional data into one or more mipmaps; a visualization module configured to display a three dimensional scene corresponding to the one or more mipmaps, the visualization module further configured to display one or more line segment or vector obtained by the importation of a .dxf file that is displayed in the correct spatial orientation of the presented scene or environment.

### BRIEF DESCRIPTION OF THE DRAWINGS

The invention description below refers to the accompanying drawings, of which:

FIG. 1 is a block diagram of a system for visualizing a three-dimensional scene according to one or more aspects of the disclosure;

FIG. 2A is a flowchart depicting an overall method of visualizing the three-dimensional scene or environment;

FIG. 2B is a flowchart depicting the conversion and/or annotation modules;

FIG. 2C is a flow chart depicting the visualization module;

FIG. 3 is a graphic user interface 300 showing the visualization software and a visualization of the scene;

FIG. 4 shows the graphic user interface above with an additional toolbar overlaid atop a portion thereof;

FIG. 5 depicts the point-to-point measurement feature according to one or more aspects of the disclosure;

FIG. 6 depicts the creation and editing of a hotspot according to one or more aspects of the disclosure;

FIG. 7 depicts a menu displaying each of the hotspots and/or measurements according to one or more aspects of the disclosure;

FIG. 8 depicts an overview map according to one or more aspects of the disclosure; and

FIG. 9 depicts another menu of toggle buttons according to one or more aspects of the disclosure.

FIG. 10 depicts an example of a graphic user interface of the visualization module according to one or more aspects of the disclosure.

### DETAILED DESCRIPTION

The present disclosure relates to a system and method for visualizing and interacting with a 3D scene according to one or more aspects of the disclosure. In some examples, a user may visualize a scene or environment to allow for inspection, annotation, measurement, etc., of the scene in order to facilitate understanding of one or more events that occurred at the scene. Examples of this application includes scenes such as accidents, crime scenes, building development, film sets and locations, or any other type of three-dimensional visualization of a real life or artificially generated environment.

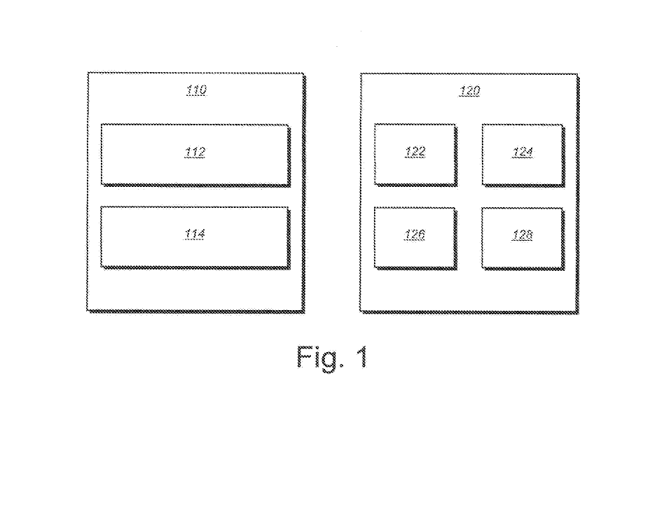

FIG. 1 is a block diagram of a system for visualizing a three-dimensional scene according to one or more aspects of disclosure.

As shown, the system can include a computing device 110 and an imaging device 120. The computing device can include a processor 112 and a memory 114. The processor 112 can have generic characteristics similar to general purpose processors or may be application specific integrated circuitry that provides arithmetic and control functions to the computing device 110. The processor can be any type of processor, such as a processor manufactured by Intel®, AMD®, or an ARM® type processor. The processor module 112 can include a dedicated cache memory (not shown for simplicity).

The memory 114 may include any suitable type of storage device including, for example, ROM, such as Mask ROM, PROM, EPROM, EEPROM; NVRAM, such as Flash memory; Early stage NVRAM, such as nvSRAM, FeRAM, MRAM, or PRAM, or any other type, such as, CBRAM, SONOS, RRAM, Racetrack memory, NRAM, Millipede memory, or FJG. Other types of data memory can be employed.

In addition to storing instructions which can be executed by the processor 112, the memory 114 can also store data generated from the processor 112. It is noted that the memory 114 can be an abstract representation of a generic storage environment. According to some embodiments, the memory 114 may be comprised of one or more actual memory chips or modules. The memory 114 can also include a non-transitory computer readable medium according to one or more aspects of the disclosure.

Although not shown, the computing device can include additional components generally associated with general purpose computers, such as a display (monitor, LCD, CRT, etc.), an input (mouse, keyboard, touchscreen, etc.), a wired and/or wireless communication link (e.g., USB, antenna, modem, etc.), etc.

The conversion, visualization, or annotation modules described below can be program instructions stored in the memory 114 (e.g., non-transitory storage medium) such that, when executed by the processor 112, can perform the functions, processes, and/or methods described in the present application. In particular, the modules can be compiled using programing languages and libraries including C, C+, C++ and C#, as well as Unity, E57, OpenEXR, BOOST and PCL, allowing the modules to be compiled into Microsoft Windows (Windows 7 8, and/or 10 compatible), Android, Apple iOS, Apple OS X, Apple TV and/or other suitable operating system.

The imaging device can include a processor 122, a memory 124, similar to the processor and memory described above. Further, the imaging device can include one or more imaging components 126 and one or more optical components 128 for capturing image data. The imaging components can include one or more analog or digital circuits for capturing an image, such as a CMOS sensor, CCD sensor, etc. The optical components 128 can include a lens, or any other type of focusing or light modification optics. In one particular example, the imaging device can include a Faro Focus 3D laser scanner. In other examples, the imaging device can include any device capable of generating or collecting 3D data (e.g., XYZ coordinate data that may or may not have associated RGB color data). Data collected by the imaging device can be transmitted to the computing device 110 by a wired and/or wireless link (not shown) or other portable storage media, such as SD card, non-transitory storage media, etc.

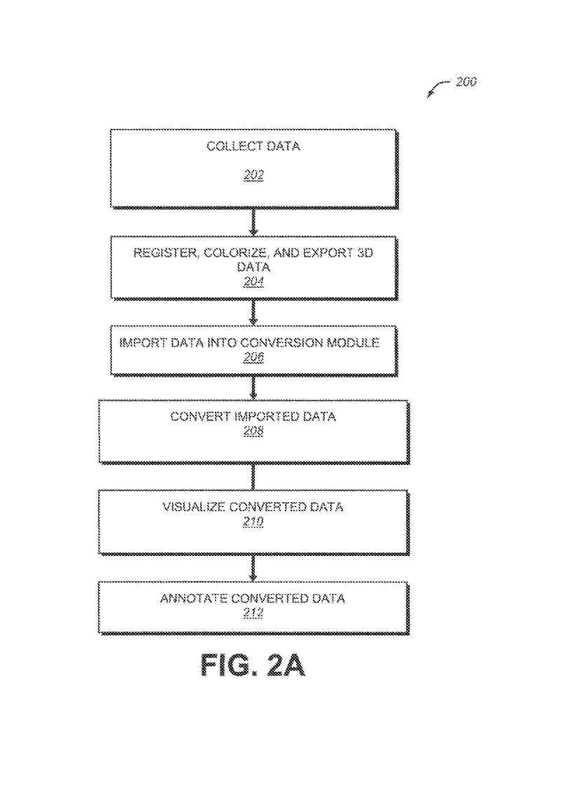

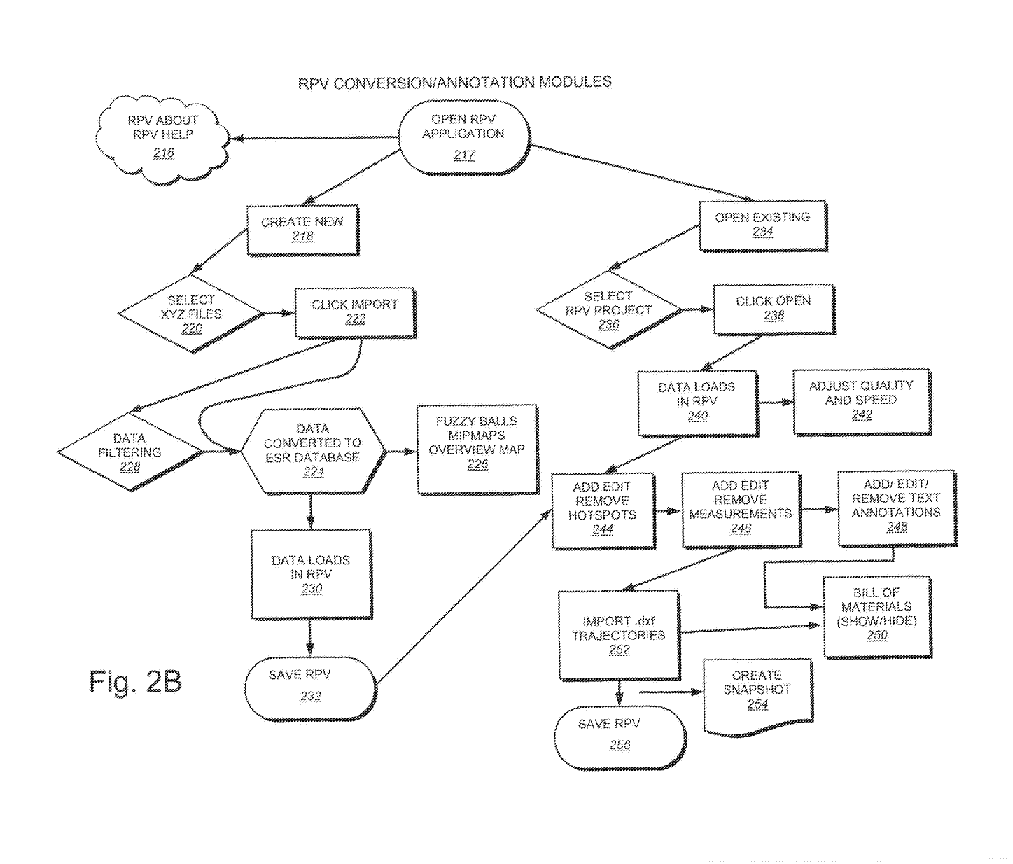

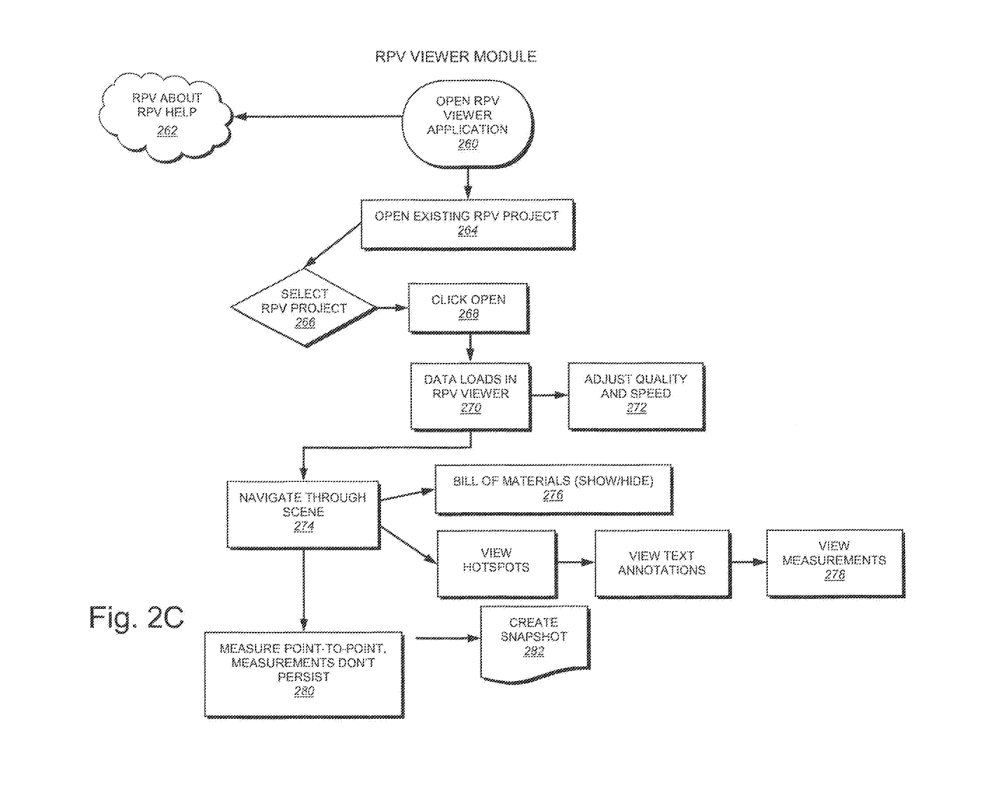

FIG. 2A is a flowchart depicting an overall method of conversion, visualization, and/or annotation of the three-dimensional scene. FIG. 2B is a flow chart depicting conversion and/or annotation of the three-dimensional scene. FIG. 2C is a flow chart depicting visualization of the three-dimensional scene.

At block 202, 3D data may be collected from a scene or environment. The 3D data may be collected by any type of device, and in one example can be collected by imaging device 120 and stored at memory 124. Such 3D data can include, for example, one or more images of the scene taken from one or more differing perspectives: high, mid and low density 3D data generated by a laser scanner (LIDAR data) using either a phase or time of flight process; a structured light or white light scanner; and/or photogrammetry systems. Data captured, such as three-dimensional (3D) data (e.g. XYZ data) or point cloud data, can be used as the input data for generating a three-dimensional visualization of the scene.

At block 204, the data collected from the scene or environment can be registered, colorized, and exported from the imaging device 120. For example, processor 122 can register and/or colorize the 3D data using 3D data processing software stored at memory 124. As described above, 3D data can be captured using a Faro Focus 3D laser scanner. Raw, proprietary Faro scan files (*.fls) can be imported into Faro Scene software where the files are registered to each other and colorized. Registration can include aligning one scan with another to ensure the two data sets are correctly orientated in 3D space (either using a local or a global coordinate system). Colorization can include applying RGB color values to the XYZ spatial data to yield XYZRGB data. Since at least some 3D scanners record the spatial data (XYZ) and the color data (RGB) as separate data sets, data processing can map the RGB values recorded to the XYZ spatial data. Multi-spectral or infrared (IR) data may be captured instead of or in addition to the visible light RGB capture.

Additional data filtering may be performed in the user's existing 3D data processing software prior to export of the 3D data. Such filtering can include, for example, deletion of unrequired data (e.g. surfaces outside the area of interest), deletion of incorrect data (e.g. reflected data from a mirror or poorly reflective surface), and noise and/or stray data points (e.g. data points that ‘bleed’ away from the true edge of a surface) that can be removed from the data set to yield a higher quality visualization.

Additional vector geometry data (that can be collected by the image sensor, imported from another data gathering apparatus, or artificially generated) can be exported at block 204 as .dxf files for subsequent importation into the visualization module as line segments or floor plans. The results of these analyses can include, for example, projectile trajectories, vehicle paths, bloodstain pattern analysis (BPA) area of origin, building information, and architectural plans.

Conversion Module

When a user desires to create a new data file for visualization at 218, a user may select one or more 3D data files (e.g., XYZRBG, XYZ, etc.) at 220 for import at 222 and block 206, as described below. Optionally, at 216, a user may access information regarding the conversion module and/or help in using the conversion module.

At block 206, the XYZRGB data set (or any other type of 3D colorized and/or registered data) exported from block 204 can be imported into the conversion module. This can be done automatically or manually, e.g., via a wired or wireless connection, electronic communication, tangible storage medium, such as thumb drive or other solid state memory, etc.

At block 208 and 224, the conversion module can convert the XYZRGB data into an internal data format comprising one or more mipmaps. In some examples, the collected data above can be in the format of *.xyz (XYZRGB), *.e57 or encrypted binary data.

During the data conversion process a data filtering tool can be applied to the data at block 228. The filtering tool can be part of the conversion module or can be a separate, standalone filtering module. This process enables the data to be cleaned and the quality of the resulting visualization to be improved by removing stray day points in the data.

The data translation/conversion process undertaken by the conversion module can output tabulated data split into resolution layers that are called mipmaps at 226. Each mipmap provides a layer of data density (resolution). A 0-layer mipmap can be generated which is a lossless layer, containing the full data density as captured by the scanner. In some examples, the 0-layer mipmap can be retained in the *.esr file for completeness, while in other examples, the 0-layer mipmap can be excluded in the interest of data volume and speed requirements. The 1-layer mipmap is set to filter the data to produce a reduced point density, for example 0.5 cm (i.e. the distance between adjacent points is 0.5 cm). This resolution setting produces a photorealistic view of the scene. The data density (point spacing) of this 1-layer mipmap can be adjusted to any value to meet user requirements, based on desired resolution, computing speed, and any other number of factors. Each of the subsequent mipmaps provides a sequential reduction in data density compared to the previous. For example, the 2-layer mipmap provides a 50% reduction in data compared to the 1-layer mipmap, and so on.

The data file format results in significant data compression without the loss of detail. Raw data formats (XYZRGB) of approximately 60 GB are compressed to approximately 20-40 GB even once the multiple resolution layers have been generated and stored within the tabulated data set. The input data can be compressed by up to 97% in some cases. The data, when compressed, edited/enriched and saved from the conversion module, can be easily shared in a non-editable format with a viewer module that does not include the data translating/conversion and scene annotation functionalities described within this disclosure.

Each data point in each of the mipmaps can also be endowed with a random angular rotation value that is used to rotate the Gaussian matte uniquely for each point. The noise function and unique rotation is a form of anti-aliasing that prevents patterns from emerging in the combination of multiple layers of points with transparency. The list of points is sorted from near to far from the location of the CG camera. For each point in the depth sorted list of points, at the point in Cartesian space, given the RGB color, a colored alpha matte is drawn in 3D.

In the final converted/translated data, one or more mipmaps are compiled into one or more data files or rpv databases at block 224. In one example, a particular data file can correspond to a particular 0-layer mipmap and its corresponding reduced mipmaps. In other examples, the data file can merely include all mipmap layers. In still other examples, the data file can correspond to various different mipmaps. The plurality of data files corresponding to a scene are collected and stored as a *.rpv project file at blocks 230-232. In this regard, the *.rpv project file can include all of the data files and mipmap data for visualizing a particular scene. As will be discussed later, the *.rpv project file can also include annotations made by a user, annotated multimedia files, measurements, hotspot information, etc., as will be discussed in greater detail below. The *.rpv file can be accessed and edited by the conversion module, or can be viewed by the visualization module in a read-only mode, as will be described in detail below.

Visualization Module

As described above, an *.rpv file can be generated by the conversion module. In some examples, the conversion module and the visualization module can be combined into a single module and the visualization can commence immediately after creation of the *.rpv file. In other examples, the conversion module and the visualization module can be separate modules. In this regard, where an existing *.rpv file already exists, an existing file can be opened and selected at 234-238.

At block 210, the *.rpv data file can be displayed by a visualization module, for example on a display unit such as a monitor, LCD, CRT, etc. For example, a user can open or access the visualization module at block 260, and optionally access help or about information at block 262. An existing *.rpv project can be accessed and selected at blocks 264-268 and the *.rpv data (including mipmap data) can be loaded into the visualization module. The visualization module will automatically initialize the configuration for optimal tradeoff between performance and speed. Optionally, at block 272, a user may adjust the quality and/or speed of the visualization module to account for higher quality and/or processing demands.

The visualization module reads the *.rpv file, accessing the translated mipmap data files to display the 3D scene in a photo-realistic and dimensionally accurate way. In some examples, a stand-alone data conversion module can be separated from the visualization module. It would enable data to be converted into the *.rpv file format prior to data being introduced into the visualization module. This would enable significant data compression to be obtained for the data being transferred from a proprietary laser scanner application into the conversion module. This would be useful if the data had to be transmitted to a remote conversion module.

Visualization of the scene or environment can occur at the visualization module. In this regard, a user can navigate the scene from a first-person point of view (e.g., at block 274) using any type of input device, such as a mouse, keyboard, USB game controller, trackpad, etc.

When a data set that has been translated into the *.rpv file format by the conversion module and is viewed/displayed using the visualization module, large volumes of data can be navigated through. The software selectively presents the information contained within the mipmaps by displaying only the nearest points in a high resolution and down-sizing/culling the rest of the data.

While moving through the scene, data from different mipmaps relating to the areas of the scene that are currently in view are loaded and unloaded to ensure a suitable level of data density is presented to the user. Data from a higher density mipmap is used for objects or surfaces that are close to the user's virtual position within the scene and data from a lower density mipmap is used for objects or surfaces that are further away.

For any particular view of a scene the visualization module presents and/or loads data from a range of mipmap resolutions—areas close to the ‘virtual position’ are presented with high resolution data; areas further away using low resolution data. The loaded and/or presented data changes as the person moves through a scene.

The visualization module can also display *.rpv data (including mipmaps) according to the “fuzzy spheres” technique. The visualization module visualizes the converted data by applying a Gaussian distributed “color sphere” over each data point to produce a 3D model-like visualization with the appearance of solid, rendered surfaces. In this regard, for a given user-specified fixed pixel size that defines a radius, a circular alpha channel matte is calculated such that it has a Gaussian falloff from opaque (center) to transparent (outer edge). A noise function can be applied to add a degree of non-uniformity. Each data point from the respective mipmap data is represented by a point in Cartesian space with an RGB color value. The fuzzy spheres are Gaussian distributed color spheres that are rendered in the view as part of the beauty render that can occur at a predetermined basis. This output can be published as one or more files stored in a single folder which is readable via a 3D graphics engine, for example the Unity gaming engine, provided by Unity Technologies.

This gives the appearance of solid surfaces and photorealistic image using the point cloud data, without having to mesh, surface or model. Not having to mesh, surface, or model, combined with the data compression associated with the mipmap conversion process, provides significant data and processing advantages over the visualization processes of the prior art.

The fuzzy spheres visualization can be applied as a beauty render that can occur at any desired time frequency. For example, it can be applied at a predetermined frequency irrespective of a user's navigation through a scene. In other examples, it can be applied a predetermined time after a user halts movement in the scene, e.g., 1-2 seconds after. In other examples, it can be applied at a first frequency during user navigation and applied at a second frequency when a user has halted in the scene. It is applied to the visualized point cloud data presented in the current field of view by the RPV when movement within the scene ceases. The beauty render converts a colored pixel of the mipmap data to present the data as fuzzy spheres, as described above. The beauty render causes the displayed image to appear visually appealing and realistic.

The visualization output by the visualization module can retain the accuracy and integrity of the raw laser scan data capture and present a visually appealing format that is comparable to photographic scene capture. It can be produced rapidly without the requirement of expensive software or the requirement to engage specialist 3D graphic artists.

At block 212, the *.rpv data may be edited or otherwise annotated, as will be described in greater detail below.

Although depicted as a linear flow process, the blocks 202-212 can be performed in any order, one or more of the blocks can be omitted, one or more additional blocks may be added, etc.

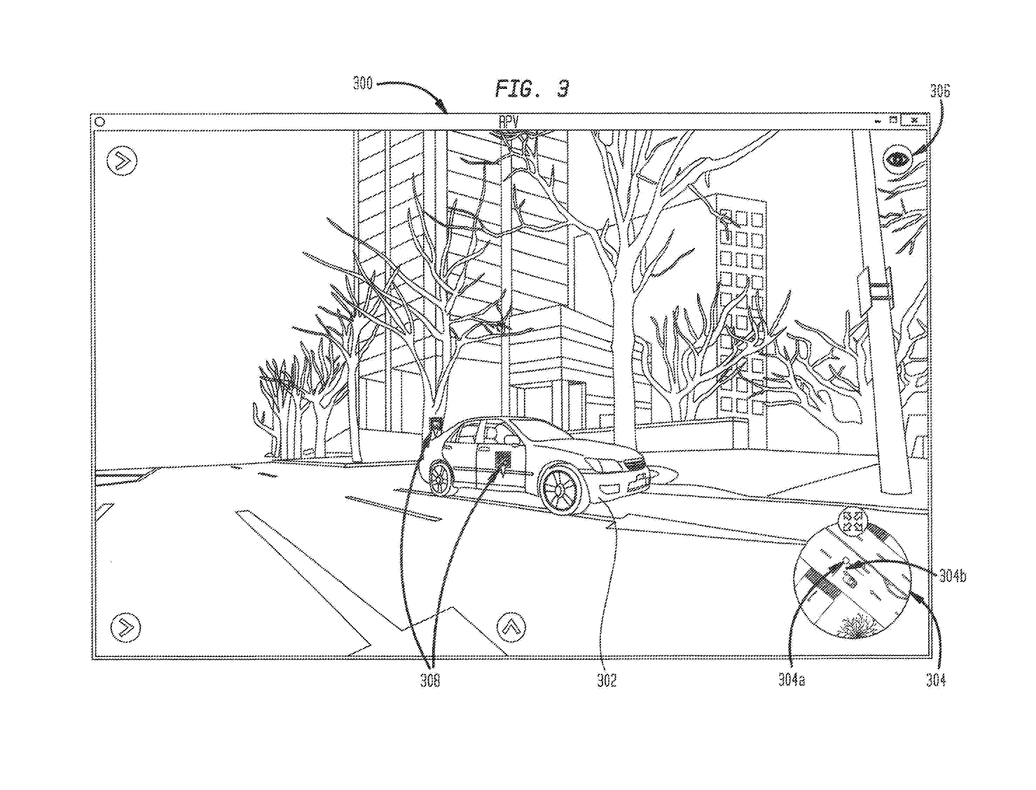

FIG. 3 is a graphic user interface 300 showing the visualization software and a visualization of the scene.

In this figure, a three-dimensional visualization of a crime scene is shown. One or more environmental artifacts that exist in the scene can be visualized, such as the car 302 shown in FIG. 3.

The graphic user interface 300 can also include an overview map 304, a view toggle 306, and one or more hotspots 308, as will be described in greater detail below. As described above, a user can navigate through the three-dimensional scene by controlling an input device, such as a keyboard or mouse. In one example, a user may utilize arrow or WASD keyboard input to navigate through the scene. In this regard, the up arrow may move a user forward, the down arrow may move the user backward, left arrow may move left and the right arrow may move right.

As the user navigates through the three-dimensional scene, the visualization module is displaying the scene by displaying the point cloud data in correspondence with appropriate mipmaps. The appropriate mipmaps can be selected based on the user's position within the three-dimensional scene. For example, as a user approaches the car, higher resolution mipmaps can be selected to display the car with greater detail and at a higher resolution.

As the user navigates through the scene, the overview map depicts the user's position with respect to an overall layout of the scene. As shown, the overview map includes an indicator 304a indicating the position of the user. Other artifacts, such as the position of the car, position of trees, buildings, or the like can also be represented in the overview map. The overview map also includes a point of view indicator 304b that indicates the point of view of the user. The point of view indicator 304b can generally be represented as a viewing cone, or triangle, oriented in the direction the user is facing. The overview map can be generated directly from the point cloud data, thereby avoiding parallel rendering/processing by the visualization module.

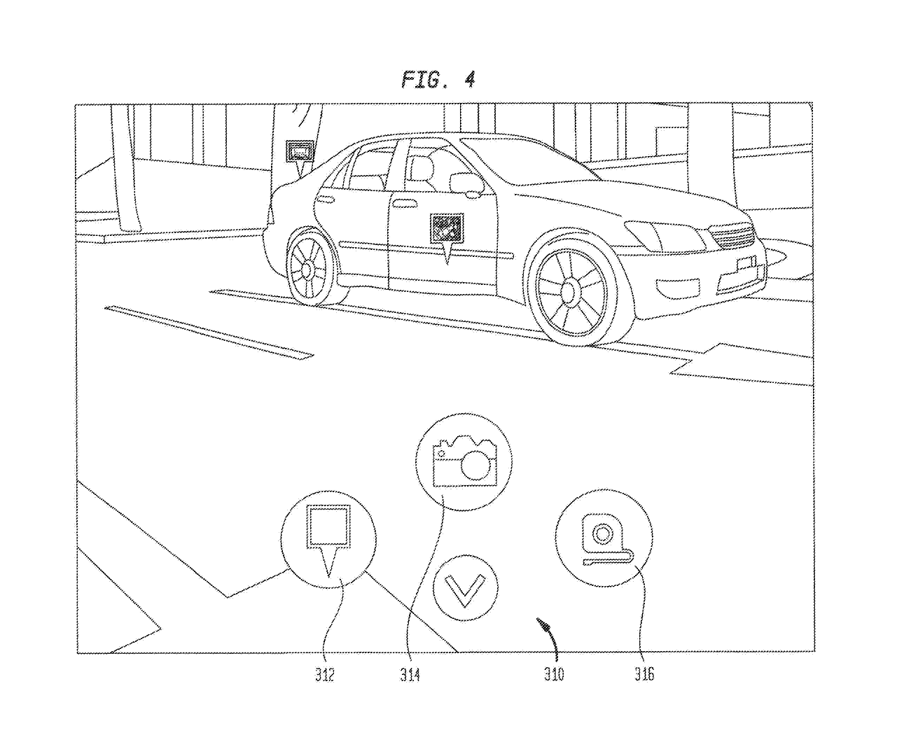

FIG. 4 shows the graphic user interface above with an additional toolbar 310 overlaid atop a portion thereof.

The toolbar 310 can include a plurality of buttons or toggles that allow the user to annotate or otherwise edit the three-dimensional visualization. Button 312 can allow a user to generate or edit a hotspot, such as the hotspot 308 described above. As shown, the label associated with the button 312 is generally in the shape of the hotspots 308 oriented in the scene. This allows the user to easily associate the hotspot editing feature associated with button 312.

Button 314 can allow a user to take a snapshot of the area of the scene currently being visualized as a *.png image file. In another example, button 314 can be placed near the view toggle 306. The resolution of the image is directly related to the resolution of the display (monitor, LCD, CRT etc.) attached to the computing device 110. As shown, button 314 includes a label generally showing a camera. This allows the user to easily associate the snapshot function with the button 314.

Button 316 can allow a user to make one or more point-to-point measurements within the scene. As shown, the label of button 316 is a tape measure, allowing the user to easily associate the measurement function of button 316. Each of these functionalities will be described in greater detail below.

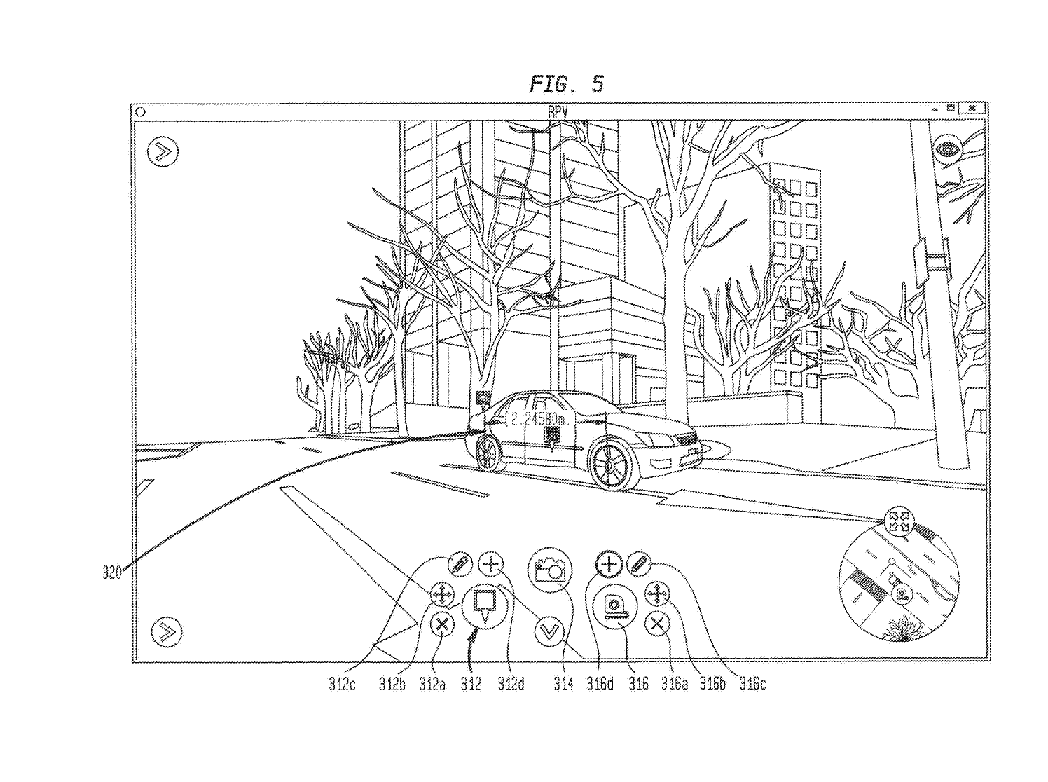

FIG. 5 depicts the point-to-point measurement feature according to one or more aspects of the disclosure. As shown, the user has selected the button 316 to engage the measurement features of the present disclosure. Upon toggling either of the buttons 312 or 316, one or more additional buttons 312a-d and 316a-d may be presented to the user. The additional buttons 312a-d and/or 316a-d provide additional functionalities to the user upon toggling the measurement or hotspot features. For example, 312a allows a user to delete a hotspot, 312b allows a user to move a hotspot, 312c allows a user to edit a hotspot, and 312d allows a user to add a new hotspot. Similarly, 316a allows a user to delete a measurement, 316b allows a user to move a measurement, 316c allows a user to edit a measurement, and 316d allows a user to generate a new measurement.

As shown, the user has created a new measurement 320. The measurement can be between two endpoints, selected by the user, in the three-dimensional scene. The measurement can provide a measurement between the two points as if the distance were measured in the actual scene.

A method of creating a measurement may include a user toggling the measurement button to toggle the measurement feature. A user may then toggle button 316d to create a new measurement. A user may then select a point in the scene, such as by a keyboard, mouse, etc. A user may then select a second point in the scene. Such second selection may include dragging the cursor, with the mouse button clicked, along a portion of the screen. In another example, a user may simply click twice on discrete portions of the scene. The length of the line segment being drawn/presented within the scene is displayed and updated in real time based on the points the mouse point is above. Upon selection of the second point, the visualization module can generate a measurement between the two points that is retained in the view. Such measurement may be calculated by finding a quadratic distance between the xyz coordinates associated with the respective first and second points.

Once created, the user may move the measurement to a different position within the scene, edit the measurement by changing one or both of the end points, or may delete the measurement entirely. If the user changes one of the end points, the measurement value displayed can update in real time in a manner corresponding to the measured distance. The orientation of the end markers of the measurement and the position of the presented measured value can also be repositioned in relation to the scene data being presented. Such measurement data can be saved and stored, along with the *.rpv file.

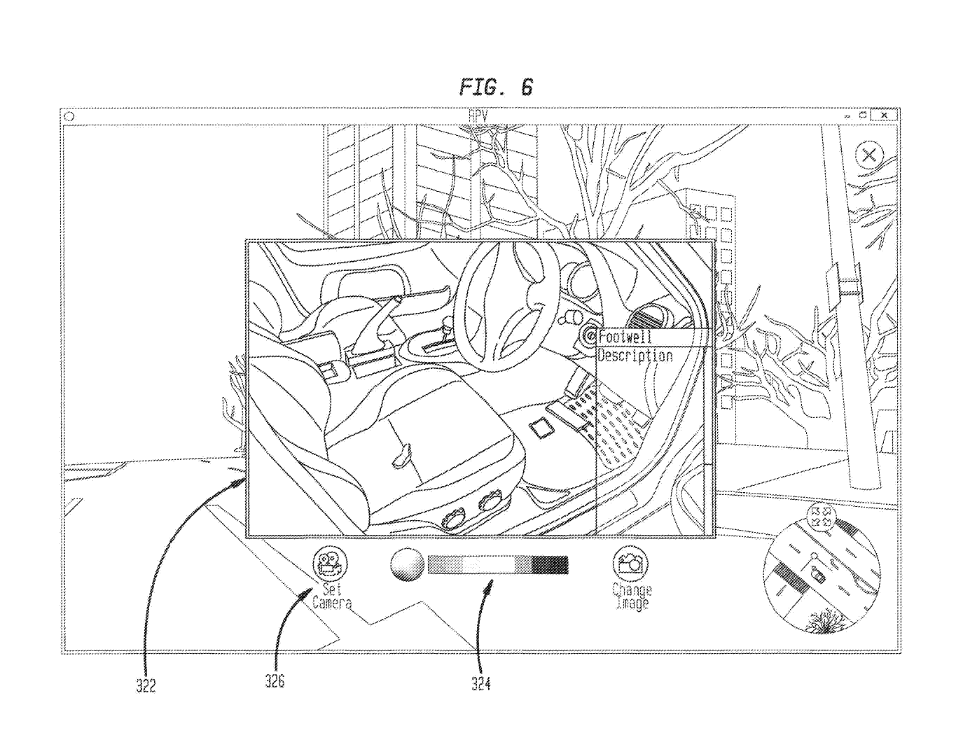

FIG. 6 depicts the creation and editing of a hotspot according to one or more aspects of the disclosure. As described above, the user may create a new hotspot by toggling button 312d. A user may select a point within the scene to be associated with the hotspot. Such point can include, for example, xyz coordinates within the scene.

Upon selection of a point within the scene, the user may annotate one or more multimedia objects, such as one or more image files, with the selected point, thereby forming the hotspot. The multimedia object can be any type of object, such as text, image, audio file, video file, spreadsheet, PDF file, webpage, instructions to execute third party software, etc. In the example of FIG. 6, the user has associated an image 322 of the inside of the car with the hotspot. Specific details regarding the scene (e.g., crime scene) can thus be viewed for this particular area within the hotspot image.

The hotspots, as well as the measurements and the text annotations described above, can be assigned a specific color to allow for organization. As shown in FIG. 6, a color palette 324 is displayed to the user. The user may select one of the preselected colors, or may use the color wheel to select a custom color for association with the particular hotspot. Hotspots, text annotations and/or measurements may be grouped with one another based on color category for ease of review.

At button 326, a user can assign a specific camera angle for the hotspot, text annotations or measurements. In this regard, when a user returns to the same hotspot later, the same camera angle can be ensured to allow for efficiency and predictability in recalling the hotspot.

Referring back to FIG. 3, hotspots 308 can be visible to the user while the user is navigating the scene. This can allow a user to easily identify the most pertinent information associated with the scene. When a hotspot 308 is selected, e.g., by mouse, a pop-up box may open containing the multimedia file. The multimedia file can be stored directly in the *.rpv file structure.

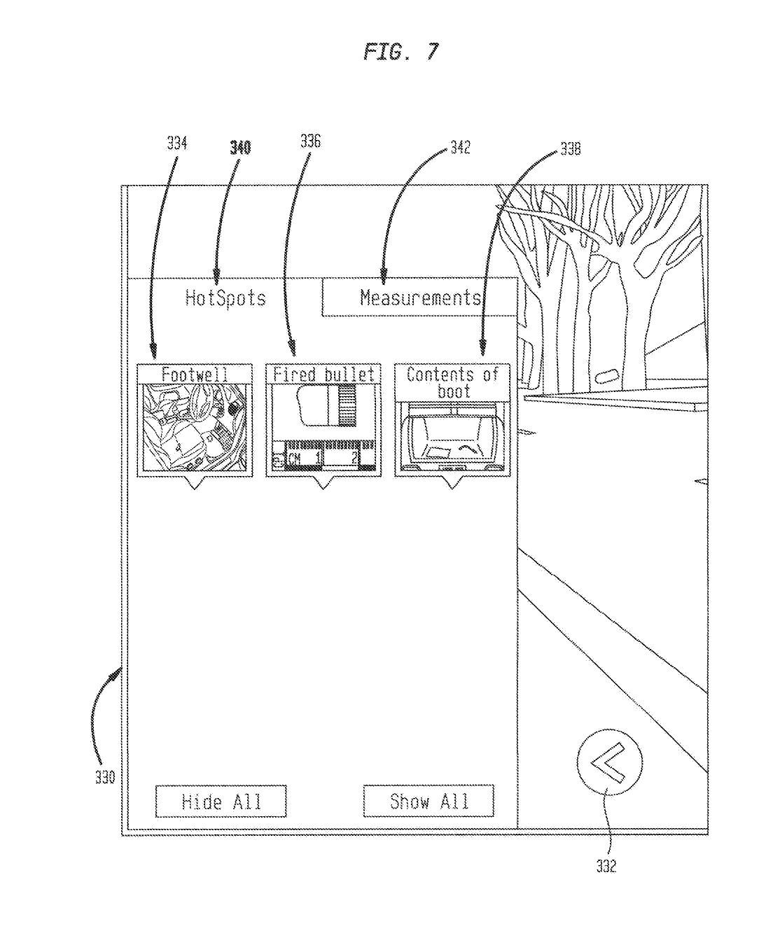

FIG. 7 depicts a menu 330 (e.g., bill of materials 330) displaying each of the hotspots and/or measurements according to one or more aspects of the disclosure. As shown, the user may toggle button 332 to access the measurement and hotspot menu. Once toggled, the menu can appear to the user on the bottom left portion of the graphic user interface 300. The menu can include respective tabs 340 and 342 for categorizing the hotspots and the measurements. In this example, the user has selected the hotspot tab 340, thereby showing a plurality of hotspot thumbnails 334, 336, and 338. The hotspot thumbnails can include a text identifier to identify the hotspot and/or a portion of the high resolution image associated with the hotspot.

The bill of materials 330 displays thumbnails of all the features or assets added to an RPV project can be viewed using the bill of materials function 332. The bill of materials is accessible from the toolbar at the bottom left of the display, an example is shown at 330.

The bill of materials includes all the incorporated hotspots, text annotations, measurements and imported .dxf vector files that have been added to an RPV project. Each added asset is presented as a small thumbnail image in the Bill of Materials summary.

Respective tabs 340, 342 within the bill of materials automatically collate the four different categories of added assets: Hot Spots, Measurements, Text Annotations, DXF Vectors. When an asset is added to the *.rpv file (refer to earlier instructions) it automatically appears within the bill of materials in its correct category. When an existing asset is edited (name, color code, fly-to viewing setting) this is also automatically updated in bill of materials

The thumbnail images in the bill of materials (see 334-338) that shows each asset that has been added to the RPV project can be placed in a user-selected order (within each tab in the bill of materials) by dragging and dropping the thumbnail.

Clicking on the thumbnail of any asset within the bill of materials will take the user directly to that asset within its location within the RPV presented scene or environment. Fly-to camera paths can also be defined and saved from within the bill of materials.

The visibility of any individual asset can be set from the Bill of Materials summary. This option allows the user to show or hide any individual asset under any of the four categories of assets. All assets within one of the four categories of assets can be shown or hidden from view at once using the bill of materials.

Upon selection of one of the thumbnails 334-338, a user can “fly to” a location near the associated hotspot to view the annotated multimedia associated with the hotspot. For example, if a user selects the “footwell” thumbnail 334, the user can be transported within the scene to a location near the footwell image shown in FIG. 6. Further, where the user has preselected a camera angle, the user's vantage point can be predetermined to the selected camera angle.

As described above, the measurements, hotspots, and text annotations associated with either can be colorized. In this example each of the thumbnails 334-338 can be associated with the color green to allow for categorization by the user. Similarly, the hotspots 308 disposed within the scene or environment can include a similar color, such as a colored frame/border or colored annotation text, to allow for the same categorization. Moreover, the measurement lines and distance value can be colorized to allow for categorization.

Vector information produced during the analysis of a 3D data set or generated in some other way can be imported into a RPV project when it is available as a *.dxf file. DXF files are presented within the same local coordinate system that the original scan data contained. Example where this type of vector information may be generated and visualized within and RPV project include projectile trajectories, vehicle paths, bloodstain pattern analysis (BPA) area of origin, building information, and architectural plans. In forensic science applications, 3D trajectory lines can be produced in specialist software applications that represent the likely path of a fired projectile or the movement of a blood droplet that formed part of an impact spatter bloodstain pattern.

(delete)

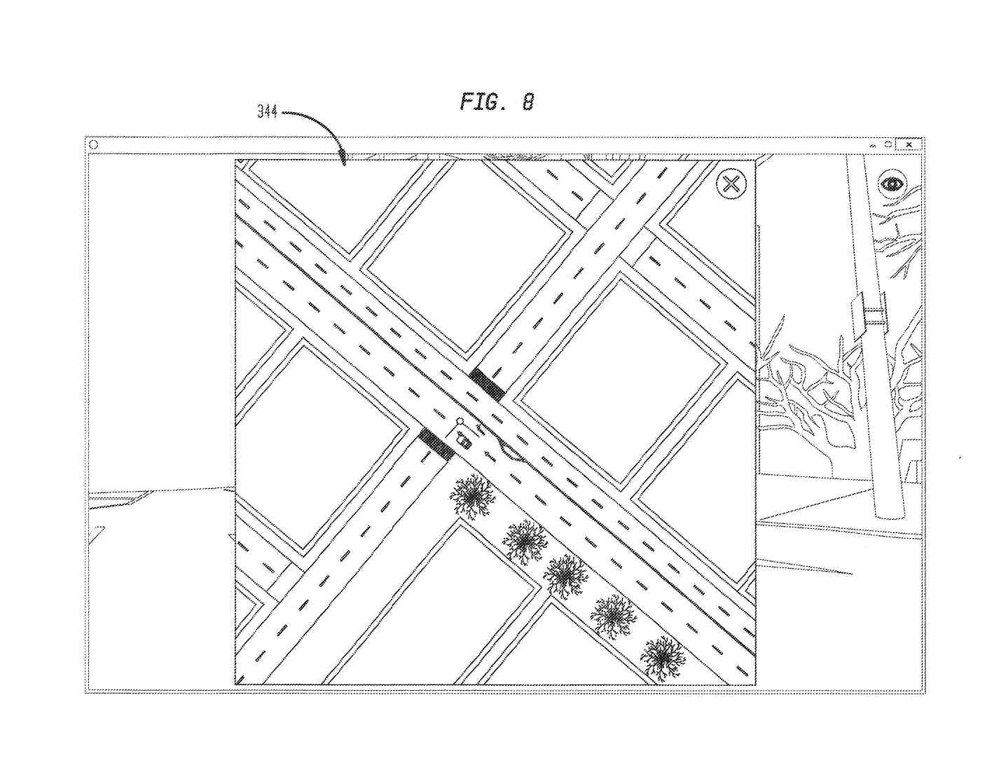

FIG. 8 depicts an enlarged overview map 344 according to one or more aspects of the disclosure. Referring back to FIG. 3, a user may select a toggle located at a perimeter of the view 304. Upon selection of such toggle, which is labeled with an icon depicting arrows in four directions, the overview map is enlarged. Within this map a radar icon displays the position of the current view within the scene or environment and the direction of view. The enlarged overview map 344 can be similar to the view of 304, but may include a larger area of the scene within the view.

The first person point of view can be changed to a fly over view 400, which allows the user to view the scene from above. Referring back to FIG. 3, a user may select a toggle 306, which is located at a perimeter of the view 300. A user may still use WASD/arrow input to navigate the scene, while viewing the scene from above.

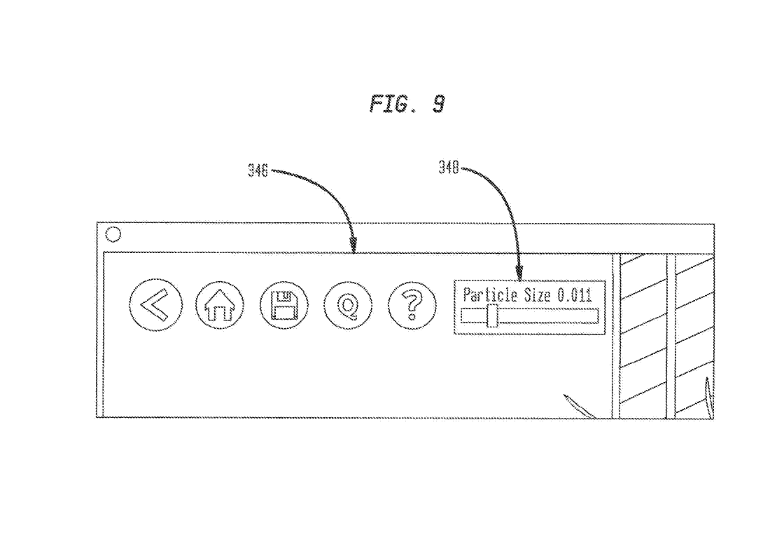

FIG. 9 depicts another menu of toggle buttons according to one or more aspects of the disclosure. As shown, the menu 346 can include a particle size slider bar 348. The particle size slider bar 348 can adjust the size of the spheres and/or data points that are rendered by the visualization module. Smaller size particles look sharper (but can look a little sparse) while larger size particles create a bigger overlap between adjacent points. Since different data sets can have different data density and data density is also a function of distance between adjacent data points, adjustment of particle size allows for increased visualization customization by the user.

The menu 346 can include further toggles for saving the scene into the respective *.rpv project file, to return to a home screen of the visualization module, or to guide the user if the user needs assistance in using the program.

As described above, button 314 allows for a snapshot to be taken from the scene, displaying the information visible in the in the user's point of view. The resolution of the image is dependent on the resolution of the screen in which the data is being viewed, so high resolution images can be created that allow for ease of viewing. Such snapshots can be saved as *.png files and allow for quick and easy viewing a portion of the scene without having to render an entire scene.

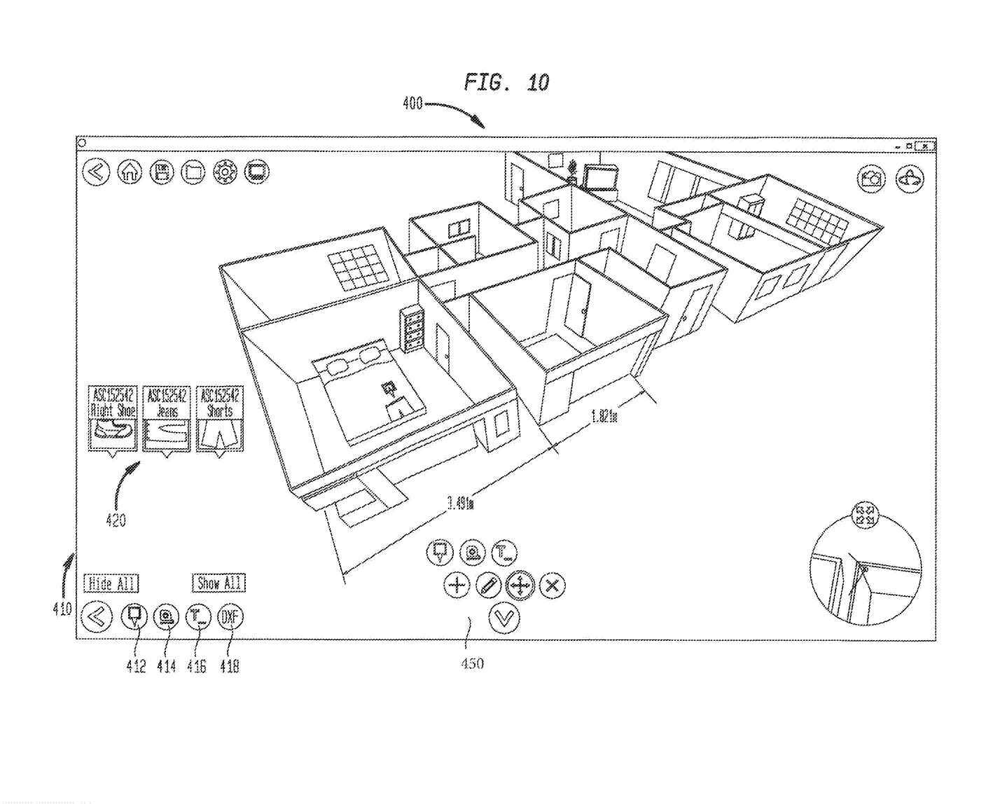

FIG. 10 is another example of a graphic user interface 400 of the visualization module. As shown, a menu 410 (e.g., bill of materials 410) can include buttons corresponding to hotspots 412, measurements 414, text annotations 416, and DXF data 418. In this regard, one or more visualizations 420 of the hotspots can be depicted. The bill of materials 410 can be displayed or hidden by a toggle adjacent to the hotspot button 412. In another example, hotspots or other annotations displayed within the scene can be shown or hidden by selecting the Hide All or Show All functions.

The annotations associated with hotspot, measurement, snapshot, DXF, etc., can be performed by an annotation module. The annotation module can be a stand alone module or can be part of either or both of the visualization or conversion modules.

The interface can also include a toolbar 450 including a plurality of buttons having various functions associated therewith that can allow a user to add, edit, move or delete hotspots, measurements and text annotations.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Note, as used herein the terms “process” and/or “processor” should be taken broadly to include a variety of electronic hardware and/or software based functions and components. Also, as used herein various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. A system for visualizing three-dimensional (3D) data, comprising:
a conversion module configured to convert the 3D data into one or more mipmaps;
a visualization module configured to display a photorealistic, three dimensional scene corresponding to the one or more mipmaps, the visualization module displaying the scene using fuzzy spheres without meshing, surfacing, and/or modeling the 3D data.

2. The system of claim 1, further comprising an annotation module configured to annotate the three-dimensional scene.

3. The system of claim 2, wherein the annotation module is configured to provide at least one of: measurements within a scene; hotspots; text; snapshots, and DXF data.

4. The system of claim 3, wherein the hotspots are displayed within the three-dimensional scene.

5. The system of claim 1, wherein the one or more mipmaps comprises a plurality of successive mipmaps of decreasing data density.

6. A system for annotating a three-dimensional visualization, comprising:
a conversion module configured to convert three-dimensional data into one or more mipmaps;
a visualization module configured to display a three dimensional scene corresponding to the one or more mipmaps, the visualization module further configured to display a measurement value corresponding to a distance between coordinates of two points among the point cloud data, the measurement value corresponding to a real life distance measurement of a scene corresponding to the three-dimensional data.

7. A system for annotating a three-dimensional visualization, comprising:
a conversion module configured to convert three-dimensional data into one or more mipmaps;
a visualization module configured to display a three dimensional scene corresponding to the one or more mipmaps, the visualization module further configured to display at least one hotspot within the visualization, the hotspot corresponding to a linked multimedia file and a coordinate of the three-dimensional data.

8. A system for annotating a three-dimensional visualization, comprising:
a conversion module configured to convert three-dimensional data into one or more mipmaps;
a visualization module configured to display a three dimensional scene corresponding to the one or more mipmaps, the visualization module further configured to display one or more line segment or vector obtained by the importation of a .dxf file that is displayed in the correct spatial orientation of the presented scene or environment.
